(19) United States
(12) Patent Application Publication
(10) Pub. No.: US 2018/0209592 A1
(43) Pub. Date: Jul. 26, 2018

(54) GENERAL PURPOSE LED LAMP WITH MOLDED RADIATOR-CASE

(71) Applicant: YURIY BORISOVICH SOKOLOV, FRYAZINO (RU)

(72) Inventor: YURIY BORISOVICH SOKOLOV, FRYAZINO (RU)

(21) Appl. No.: 15/539,990

(22) PCT Filed: Dec. 26, 2014
(86) PCT No.: PCT/RU2014/000997

§ 371 Date: Feb. 21, 2018

(51) Int. Cl. F21K 9/64; F21K 9/232; F21S 8/08

(52) U.S. Cl. CPC F21K 9/64; F21S 8/086; F21K 9/232

(57) ABSTRACT

The invention relates to lighting technology, and specifically to the design of general-purpose LED lamps. The technical result of the claimed solution consists in increasing the ease of manufacture and the luminous efficacy of a lamp. A general-purpose LED lamp contains a cast housing/radiator made of a dielectric thermally-conductive material; a light diffuser, affixed to the housing/radiator; LEDs, mounted on a board; and a metal thermally conductive element in the form of a curved profiled strip which is covered on all sides in a layer of dielectric thermally-conductive material in such a way that the thermally conductive element has, on all sides, a surface of convective heat transfer with atmospheric air. The invention allows for increasing the power of utilized LEDs without increasing the dimensions of a lamp, which is achieved by means of increasing the heat transfer surface without increasing the dimensions of the lamp.

### ART

Invention belongs to illuminating engineering, notably, to the structure of general purpose LED lamps.

### STATE OF THE ART

General purpose LED lamps usually have the following major units and elements: axially symmetrical convex light-diffusing casing, LED board, axially symmetrical radiator for convective heat exchange, built-in power source and a cap for connection with electrical network. Different auxiliary elements, which the lamp may be equipped with, increase the operating efficiency of units and elements.

One of the most important problems is ensuring operating temperature field of diodes and the power source. Moreover, their thermal interference becomes a separate problem. In any case, the problem of heat excess discharge is solved by convective heat exchange between the radiator surface and atmospheric air. The more powerful diodes are used, the more actual is the question, how fast it is necessary to discharge the emitted heat to the convective heat exchange surface.

There is a LED lamp, containing a radiator-case, made of electric insulating material, having a surface of convective heat exchange with atmospheric air; light diffuser, fixed at the radiator-case; LED diodes, mounted on the board; heat conducting element, mounted with a possibility of heat exchange with the light emitting diodes board and with the radiator-case; LED diodes power source; and a cap (TW 201405067, MΠK F21V3/04, published Jan. 2, 2014).

The disadvantage of the present decision is the presence of a closed cavity inside the radiator, where the power source is situated, which is also a heat source. And. LED diodes board, which is also a heat source, is mounted on the outer surface of the cavity wall, and its cooling is obstructed by the light diffusor, forming an air heat insulator. Both heat sources: diodes and the power source, influence each other negatively, and the power source is the weak point, operating temperature of which is considerably lower, than of light emitting diodes.

There are other decisions known, for example, CN203477931, JP539258 7 82 B2, CN203500894 O, CN 203731137 O, the common feature of which is the location inside the power source close-space, which is subject to light emitting diodes thermal action.

The decision, described in TW 201405067, is selected as a prototype because it is the closest to the claimed invention according to the quantity of matching criteria.

The technical result of the claimed invention is the increase of the lamp workability and luminous efficacy.

### Disclosure Of Invention

The claimed invention is characterized by the following group of characteristics:

General purpose LED lamp, consisting of a, molded radiator-case, made of dielectric heat conducting material; light diffusor, fixed on the radiator-case; diodes, mounted on the board; heat conducting element, made of metal with high degree of heat conduction, mounted with a possibility of heat exchange with the board of diodes and with the radiator-case; diodes power source; and the cap, characterized by the fact, that the heat conducting element is made as a bent profiled strip, covered by the layer of dielectric heat conducting material from all sides, which has a surface of convective heat exchange with atmospheric air from all sides.

A specialist should understand, that a molded radiator-case in any version of a LED lamp should include at least a heat conducting element. Versions may have a board of diodes, housing inside the radiator-case or an additional board for the power source, a cap or a surface for its mounting.

The phrase “convective heat exchange” in the claim is understood as a process of transferring the heat from the surface of heat conducting radiator-case to the moving gas environment, in this case to atmospheric air.

The purpose of heat conducting element is in quick discharge of heat excess from light emitting diodes to the radiator convection surface. Maybe heat conductivity of radiator-case material will reach the heat conductivity of metal, then production of heat conducting element is possible from the material of radiator-case.

The claimed decision provides using of a circuit board of diodes on dielectric or metal base.

Depending on the used base of circuit board the optimum variant of heat conducting element is selected. Generally, heat conducting element is a bent profiled strip of different degree of length, made of aluminum, copper or their alloys, and a radiator-case, covered by dielectric material from all sides in the process of its formation in a transfer mold. Essentially, heat conducting element, covered by dielectric material also serves as a radiator-case spatial structure.

The ends of the bent heat conducting element may have extra sections of bending, the form of which is defined by structural peculiarities of the lamp. The area between the ends of the bent heat conducting element, covered by dielectric heat conducting material, filled with atmospheric air and remains constantly open for convective heat exchange with the surface of dielectric layer, covering the heat conducting element. Thus, without changing the dimensions of the lamp, the cooling area may be increased twice, and there will be conditions created for heat discharge from the diode board on the shortest distance to the convective heat exchange surface, located between the ends of the bent heat conducting element. To increase the efficiency of cooling, the surface of convective heat exchange may be relief. The shape of relief is selected subject to heat exchange needs. Some variants are presented in drawings of the description.

In the simplest case, metal strip of the heat conducting element material may have a rectangular profile and the same width along the whole length. Even so, besides bending operation, heat conducting element material strip doesn't need extra metal working.

A more complicated variant of heat conducting element is possible, when a wider section, formed during cutting from a workpiece of suitable width strip is made, on its flat section, intended for diode board mounting. Following operation of strip bending is performed via the same equipment, as cutting.

Using a profiled strip for heat conducting element has a number of advantages, allowing creation of even luminous flux with a wide angle of dispersion. Strip profile, at flat faces of which dielectric plates on flexible base, performed in the shape of LED strip with an adhesive layer, are fixed. To increase the efficiency, the lower surface of the profile may have a wavy shape, increasing the surface of heat exchange with the layer of radiator-case dielectric material.

While using high power light emitting diodes, the power source may be located on extra circuit board, mounted along the lamp axis with a possibility of mechanical and electrical connection with the light emitting diodes board, and with the cap without using equipment wires. And there may be extra light emitting diodes mounted on the power source board for chromaticity correction or luminous flux photometric characteristics improving.

Power source construction variant in a lamp, may be its location in the cavity in the radiator-case in some distance from the heat conducting element and having a surface of convective heat exchange.

### BRIEF DESCRIPTION OF DRAWINGS

Claimed decision is illustrated by the following drawings:

In FIG. 1 general view of one of LED lamp variants is represented,

FIG. 2 shows a lamp section, represented in FIG. 1 and having a heat conducting element with rectangular profile;

FIG. 3 shows cross-section of the lamp version with a longitudinally mounted board with a power source and LEDs;

FIG. 4 shows cross-section of the lamp version with a convex section of location of LED board on flexible base;

FIG. 5 shows a lamp version, where a power source with add-on components, located in special hermetic cavity, made during molding.

General purpose LED lamp consists of a molded radiator-case 1, made of dielectric material, having a surface 2 of convective heat exchange with atmospheric air; diffusor 3, fixed at the radiator-case 1; LEDs 4, mounted on the board 5; heat conducting element 6 is mounted with a possibility of heat exchange with the board 5 and the radiator-case 1, the power source (not shown), is located in the cap 7.

Heat conducting element 6 is covered by the layer of dielectric material 8 from all sides, the radiator-case is also molded from this material. Creation of surface 8 of heat conducting element 6 and radiator-case 1 molding happens simultaneously in the molding form. All surfaces of convective heat exchange are formed in the molding form and are not subject to after treatment. The exception may be made for applying an extra electrical insulation cover on the convective heat exchange surface, which is already formed.

### Embodiments

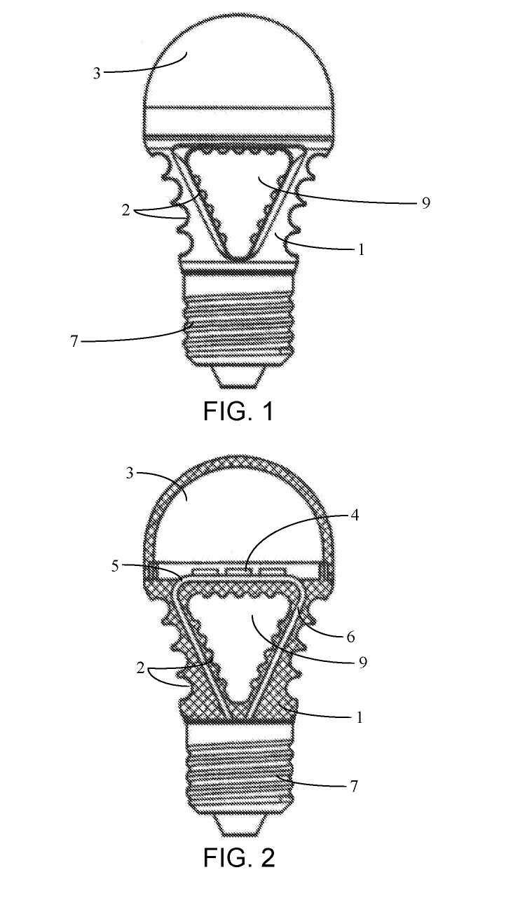

One of simple versions of the claimed decision is presented in FIG. 1 and FIG. 2, where LEDs 4 are mounted on the flat section of the heat conducting element 6 of rectangular profile, and a power source (not shown) is assembled at one of its far ends, located in the cap 7. Cover of heat conducting element 6, completed in such a way by layer 9 of dielectric material, forming of radiator-case 1 and its connection with the cap 7 is performed simultaneously, by casting of dielectric material in liquid phase into a molding form. After dielectric material curing, diffusor 3 is mounted on radiator-case 1. As a result of layer 9 curing of dielectric material, covering heat conducting element 6, there is an area 9 formed, not filled with dielectric material, available for atmospheric air free access, participating in the process of convective heat exchange with layer 9 surface, which is continuation of radiator-case I convective surface.

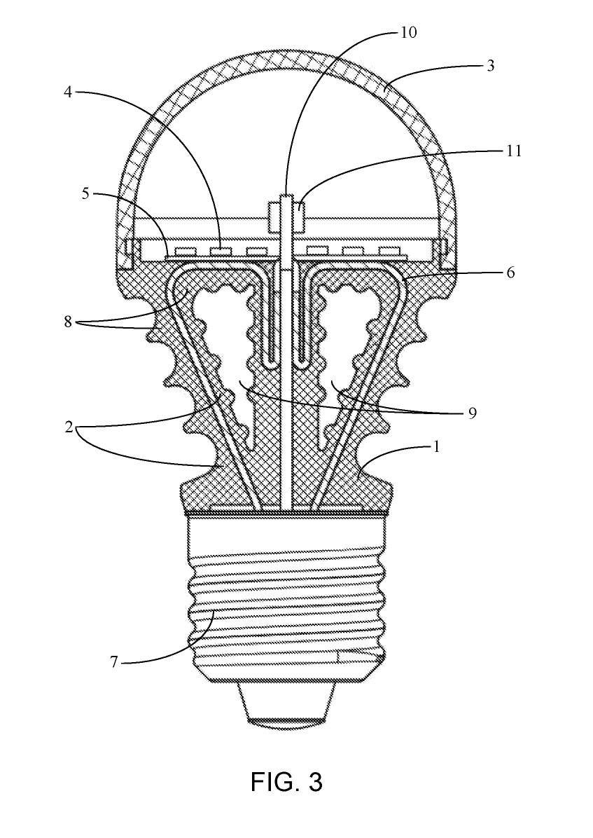

FIG. 3 shows a lamp version, which is different from the version, presented in FIG. 2 by the fact, that power source (not shown) is mounted on auxiliary board 10, equipped with auxiliary light emitting diodes 11 and installed longitudinally with the lamp axis, with a possibility of heat exchange with heat conducting element 6. And layer 8 of dielectric material, covering heat conducting element 6 covers auxiliary board 11 as well, together with the power source elements. The process of covering with layer 9 and connecting lamp parts is equal with the process, described in the previous paragraph.

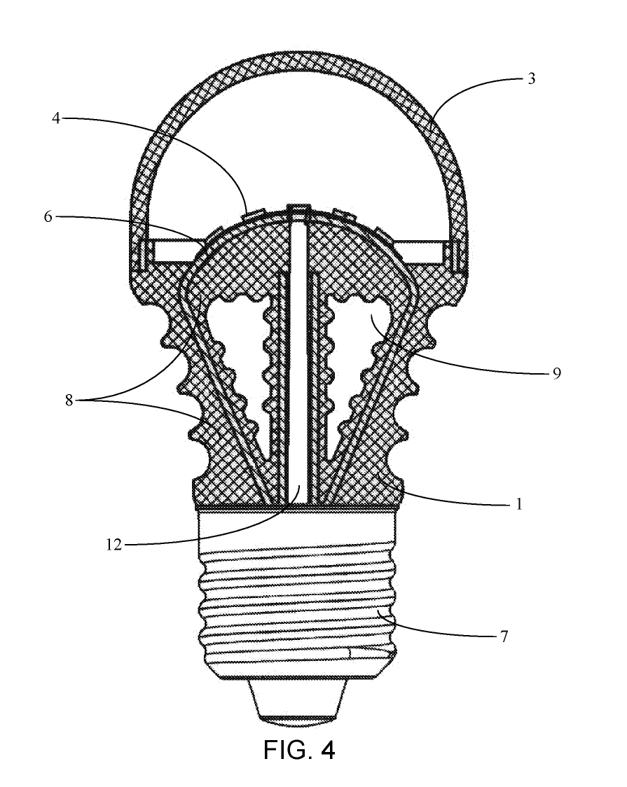

Lamp version, presented in FIG. 4 is characterized by convex form of the section, where flexible light emitting diodes board is located on heat conducting element 6, and it allows obtaining a wide entrance angle aperture.

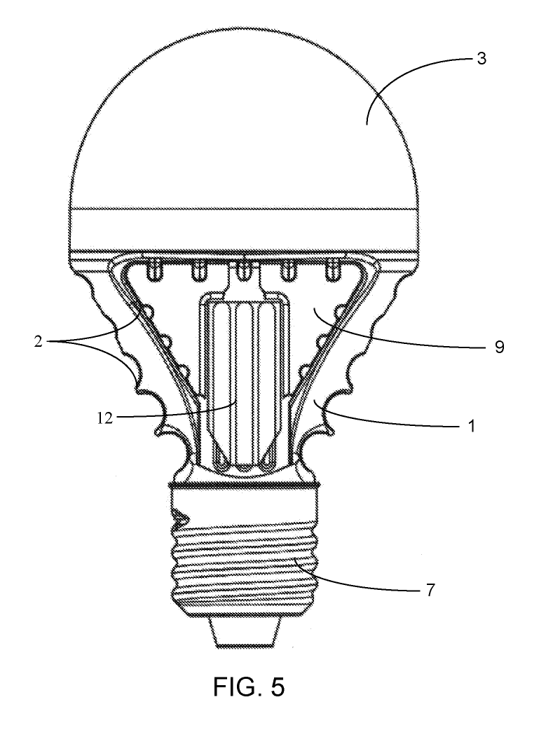

FIG. 5 shows the lamp version, where a power source with add-on components is used, located in special hermetic cavity 12.

### POSSIBILITY OF INDUSTRIAL APPLICATION

The technology of LED lamp elements manufacturing is known worldwide, well adapted and provided with productive machines of different degree of automation.

1. General purpose LED lamp, consisting of molded radiator-case, made of dielectric heat conducting material; light diffusor, fixed on the radiator-case; light emitting diodes, mounted on the board; heat conducting element, made of metal with high heat conduction degree, installed with a possibility of heat exchange with the LED board and with the radiator-case; LED power source; and a cap, characterized by the fact, that heat conducting element is made as a bent profiled strip, covered by the layer of dielectric heat conducting material from all sides, which has all-side surface of convective heat exchange with atmospheric air.

2. According to point 1, general purpose LED lamp is characterized by the fact, that at least heat conducting element is covered with radiator-case dielectric material.

3. According to point 1, general purpose LED lamp is characterized by the fact, that heat conducting element, LED board and/or power source, and/or cap cavity are covered with radiator-case material.

4. According to point 1, general purpose LED lamp is characterized by the fact, that heat conducting element is made of rectangular profile strip, having sections of different width.

5. According to point 1, general purpose LED lamp is characterized by the fact, that LED board is mounted on the section of heat conducting element surface, and the power source is mounted on the auxiliary circuit board, installed longitudinally with the lamp axis with a possibility of heat exchange with the heat conducting element.

6. According to point 5, general purpose LED lamp is characterized by the fact, that auxiliary board is equipped with LEDs.

7. According to point 1, general purpose LED lamp is characterized by the fact, that heat conducting element profile is formed by sections of the straight line and/or second order line, and LEDs are mounted on the circuit board with a flexible base.

8. According to point 1, general purpose LED lamp is characterized by the fact, that the power source is located in the cavity in the radiator-case, separated by the air gap.
